(19) United States
(12) Patent Application Publication
(10) Pub. No.: US 2006/0170760 A1
(43) Pub. Date: Aug. 3, 2006

(54) Method and apparatus for managing and distributing audio/video content

(75) Inventors: Tazwell L. Anderson JR., Atlanta, GA (US); Michael Connell, Roswell, GA (US)

Correspondence Address: Dean D. Small;Armstrong Teasdale, LLP, Suite 2600, One Metropolitan Square, St. Louis, MO, 63102, US

(73) Assignee: Collegiate Systems, LLC, Atlanta, GA (US)

(21) Appl. No.: 11/145,620

(22) Filed: Jun. 6, 2005

Related U.S. Application Data
(60) Provisional application No. 60/648,468, filed on Jan. 31, 2005.

(51) Int. Cl. H04N 7/14

(52) U.S. Cl. 348/14.04

(57) ABSTRACT

A video content distribution and management system is provided that comprises an event content recorder recording video content associated with an event as an event recording. A workstation stores and edits the event recording to form a composite event review file that is passed to a system manager over a restricted access network. The workstation is located remote from a system manager. The system manager automatically routes the composite event review file to the workstation which enables a user to designate a video segment from the composite event review file. The workstation forms a video clip from the video segment and enables the user to add annotation information to the video clip to form an annotated video clip. The workstation conveys the annotated video clip to the system manager for redistribution.

### RELATED APPLICATION

The present application relates to and claims priority from Provisional Application Ser. No. 60/648,468 filed Jan. 31, 2005, titled “METHOD AND APPARATUS FOR MANAGING AND DISTRIBUTING VIDEO CONTENT”, the complete subject matter of which is hereby expressly incorporated in its entirety.

### BACKGROUND OF THE INVENTION

The present invention generally relates to methods and apparatus for managing, editing, and annotating and distributing video content, such as for sporting events.

Today, in most major collegiate and professional sports, videotapes of the sporting events are utilized by coaching, officiating and conference/league regulators for various reasons. For example, competing teams exchange videos in order that the coaching staffs utilize videotapes of prior events to train players and develop game plans for subsequent games. In college sports, each team is provided with a video of their next opponent's prior game for preparation for the upcoming game. These videos is made available to each team prior to the upcoming game which may provide a limited time period in which the video may be utilized.

As another example, video of each event are provided to the conference/league main office for review by conference/league officiating coordinators. The videos are also reviewed by technical assistants to analyze the actions, judgments and overall performance of the officials for each game. The technical assistants provide written reports critiquing, where appropriate, individual officials in connection with particular plays. The reports for each individual official are then provided to the individual officials. Each team of officials review the prior week's game a day or two before the next week's game.

However, the conventional system suffers from several disadvantages. First, the videos associated with each game are currently duplicated to an expensive hard drive disk. The disk is then taken to an airport and sent by overnight delivery to the conference office. A second set of disks is also sent to the various teams on the sending teams schedule. In addition, a VHS copy of the event video is sent overnight to the director of officials and his technical assistants. A significant delay occurs between the time that the tapes are completed (e.g., typically late in the night after each game ends) and when all interested parties are provided a copy. For example, the VHS tapes and hard drives are first sent to the director of officials for Monday delivery. He then forwards the VHS tapes to his technical assistants for Tuesday delivery. The technical assistants critique the video and forward their written comments by fax to the game officials, and also send overnight a video copy to the head of the officiating crew, the referee, for his use in his pre-game meeting, prior to the following game. Both the VHS tapes and Tape Drives must be sent to the various destinations through some commercial carrier. As most games are played on weekends, a special commercial carrier may be used to pick up and deliver the tapes.

A need remains for improved methods and systems for managing and distributing video content related to sporting events.

### BRIEF DESCRIPTION OF THE INVENTION

Embodiments of the present invention generally relate to systems and methods for managing distribution of video content between colleges. A system is provided that comprises a first server located at and associated with a first college. The first server receives an original or reformatted event recording associated with an event that is related to the first college. The first server is configured to transmit the event recording over a restricted access network. A system manager is provided that is remote from the first college and is configured to communicate with the first server over the restricted access network. The system manager receives the event recording from the first server over the restricted access network. The system manager reroutes the event recording over the restricted access network to a second server located at a second college.

The event recording may include, among other things, at least one of a recording of a complete event, a reformatted multi-view recording of the event, portions of an event, functional segments of an event and the like. Files containing comments associated with the event and teaching assistant critique files storing critique information associated with an individual official or player at a sporting event may also be joined to the event recording to form an annotated event recording. An event content recorder/editor may be located at the first college for reformatting the event recordings into multi-view recordings. The recorder/editor segments the event recording of a game into functional segments divided based on play type. A workstation is also provided for reviewing the event recording, multi-view recordings and functional segments and for annotating them with critique information associated with the event. The system manager may form an annotated event review file based on the multi-view recording and critique information associated with the event. The system manager transmits the annotated event review file to a destination IP address based on a routing log. The routing log may store a routing schedule in a one to one relation with source/destination IP addresses. The system manager reroutes various types of recordings based on the routing log.

In accordance with one embodiment, a method is provided for managing distribution of video content between colleges. The method comprises receiving, at a first server associated with a first college, an event recording associated with an event related to the first college. The method also includes transmitting the event recording from the first server over a restricted access network to system manager. The event recording is then rerouted from the system manager back over the restricted access network to a second server associated with a second college.

### BRIEF DESCRIPTION OF THE DRAWINGS

FIG. 1 illustrates a block diagram of a system formed in accordance with an embodiment of the present invention.

FIG. 2 illustrates a display formatted in accordance with an embodiment of the present invention.

FIG. 3 illustrates a block diagram of a system formed in accordance with an alternative embodiment of the present invention.

### DETAILED DESCRIPTION OF THE INVENTION

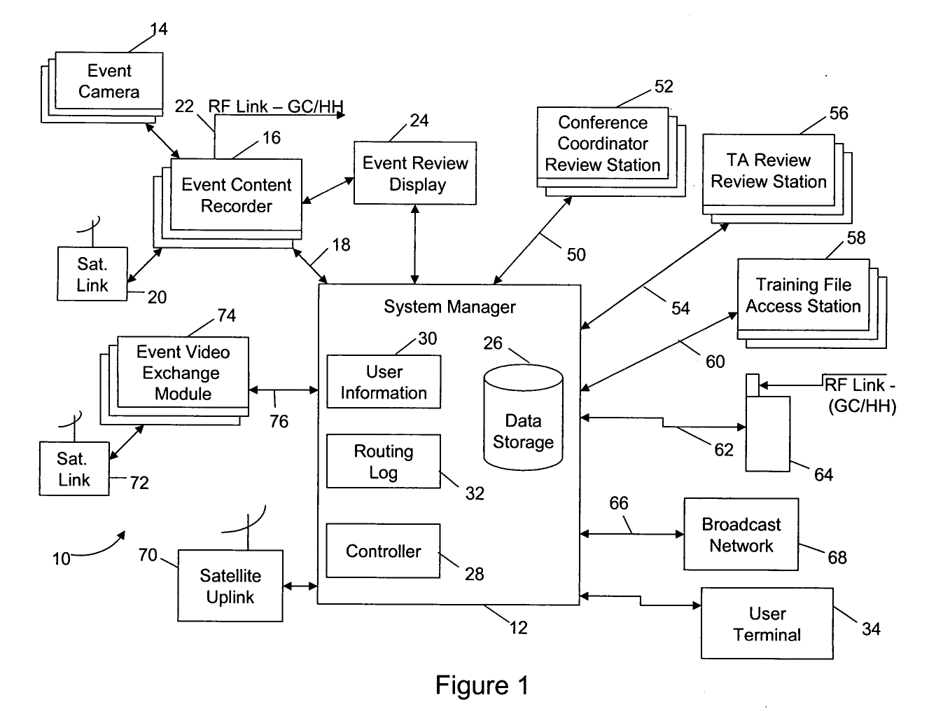

FIG. 1 illustrates a block diagram of a video transmission and management system 10 formed in accordance with an embodiment of the present invention. The system 10 includes a system manager 12 that communicates with a variety of components through links associated with any of several communications mediums (e.g., a cable Inc., a fiber-optic network, an RF link, a wireless connection, a satellite connection, and the like). Information transmitted over the various links may be analog or digit, and may be formatted in various manners (e.g., based upon Internet protocols and the like). The links may represent a T1 connection, a T3 connection, and the like.

The system 10 is configured to transmit and manage, in a secure manner, audio and video content related to collegiate events, such as academic events and sporting events (e.g., football games, basketball games, baseball games and the like). In at least one embodiment, the system 10 facilitates game preparation and review by leagues, officials and coaching staffs of various sporting events with respect to past games played by conference, the teams and/or opponents. The system 10 provides transmission and management of audio and video content for officiating review by providing a platform for instruction and continuing education of sporting event officials. The system 10 provides digitally stored copies of previously recorded sporting events for officials to review during pre-game conferences. The system manager 12 manages a library of sporting event audio/video recordings that are made assessable to appropriate individuals for viewing. The system manager 12 creates audio/video products for distribution to conference coordinators and individual colleges, as well as providing a video library for consumers to access, to watch and study past events.

The system 10 includes multiple event cameras 14 (which have microphones) located at predetermined and/or mobile positions about an event (e.g., football, baseball, basketball, hockey, and the like). For example, event cameras 14 may represent the cameras provided along the sidelines, end-lines, pit-stops and overhead at a sporting event, provided on or within the field of a sporting event (e.g., at bases of a baseball game, at line markers on a football field and the like), provided within the equipment used by players (e.g., cameras provided in the helmets of football, baseball, or hockey players, helmets on skiers, or in the automobiles of an auto-race). The cameras 14 provided audio and video content to an event content recorder/editor 16. The recorder/editor 16 is a user-operated workstation (e.g., PC) that is programmed to offer functionality described below. One or more event college recorder/editor 16 may be provided at each event to record audio/video content from one or more cameras 14 and microphones. The recorder/editor 16 includes a display, to display the event recordings while being edited by the user, and a user interface to enter recording and editing commands (e.g., fast forward, rewind, stop, pause, splice, slow forward, slow rewind, crop, mark point as sync point, mark segment start and stop, mark segment function type and the like).

The event operator loads the content recorder/editor 16 with the event content (e.g., audio and video) from the cameras 14 as an event recording (e.g., audio and video) in analog form, such as on a tape or digitally in electronic form (e.g., on a disk). An event recording may be generated for each individual camera 14, or alternatively for only certain cameras 14. The recorder/editor 16 converts analog tapes to a digital format. Alternatively, the recorder/editor 16 may receive analog signals in real-time from the cameras 14, over land-lines or wirelessly, as the event is played and, begin converting the analog signals to digital form while the event is on-going to store the event recording in digital form. Alternatively, the recorder/editor 16 may receive the event content directly from the event cameras 14 in digital form and store it digitally.

FIG. 4 illustrates a flow chart of the processing steps that may be carried out by an operator and the recorder/editor 16. At step 200, the event recordings from separate cameras 14 are loaded into the recorder/editor 16. Each event recording includes one or more video tracks and one or more audio tracks generated by the corresponding camera 14. In step 202, the recorder/editor 16 synchronizes multiple video tracks (from an equal number of cameras). Synchronization may be done manually or automatically based on time stamps and frame numbers recorded with each recording track. By way of example, a time stamp may be inserted into the event recording at the beginning of the each quarter of a football game, or more frequently (e.g., each time the play clock is restarted). The time stamps are associated with the corresponding frames within the associated video and/or audio tracks. Alternatively, the event recordings may be synchronized based on timing information independent of the event, such as the time of day, or periodic time markers simultaneously inserted by each camera 14 based on the time of day. Optionally, the recorder/editor 16 need not utilize time stamps and frame numbers to perform synchronization. For example, the synchronization in step 202 may be achieved manually by an operator viewing multiple event recordings side by side simultaneously. During manual synchronization, the operator may view multiple recordings on a single display and advance/rewind the recordings individually until temporally aligned in time such that frames from each event recording corresponding to the same instant in time are co-displayed.

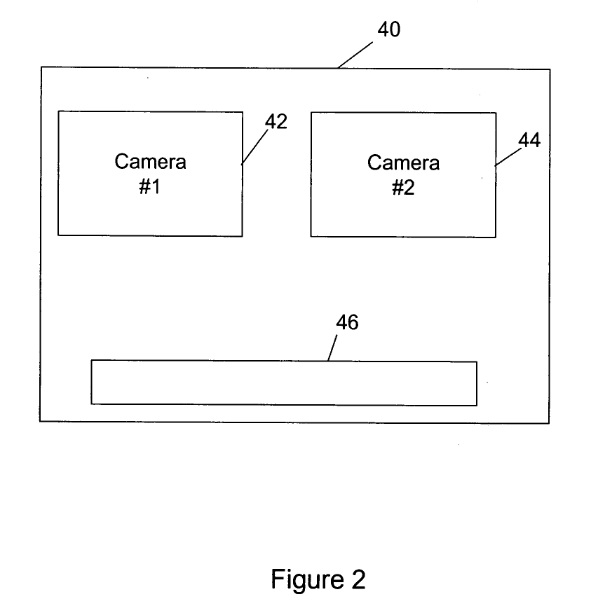

At step 204, the recorder/editor 16 reformats the video from each of the video tracks in order to co-display multiple video tracks simultaneously within a single display. FIG. 2 illustrates a monitor for the recorder/editor 16 showing an exemplary format in which the video tracks from two cameras are reformatted to be displayed simultaneously, side-by-side. At step 208, the operator instructs the recorder/editor 16 to record the combined video tracks as a common, single multi-view recording. The multi-view recording combines multiple video tracks formatted in a co-displayed manner for simultaneously replay. Optionally, the combined multi-view recording may be joined with a selected audio track. The audio track may be from a designated one of cameras 14 or from an independent source. Alternatively, the audio track may be entirely left out. Alternatively, the audio track may be a combination of audio signals picked up from multiple sources. Alternatively, the audio track may be generated by interleaving portions of audio from different cameras 14 sequentially with one another. For example, when play is near the end-zone, the microphone from the end-zone camera may be utilized, whereas when play is located proximate the center of the field, the sideline camera microphone may be utilized.

At step 210, the operator utilizes the recorder/editor 16 to partition the multi-view recording into track portions, each track portion of which is associated with a single event function (e.g., offense, defense, special teams). For example, the operator may step through the multi-view recording and designate, at the user interface (e.g., a mouse and keyboard) starting and stopping points for each play or for each offensive series of related plays. The operator directs the recorder/editor 16 to portion the multi-view recording into a collection of track portions associated with all offensive plays for one team, a collection of track portions associated with all defensive plays for one team and a collection of track portions associated with all special team plays. Each individual offensive play may represent a track portion, or alternatively; an entire series of offensive plays associated with a single drive may be designated as a single track portion.

At step 212, the operator instructs the recorder/editor 16 to assemble the track portions for related event functions to form function specific segments. For example, one function specific segment may represent all of the offensive plays for one team, where the offensive function segment is comprised of a series of track portions associated with individual offensive plays or individual offensive series. In addition, a separate functional segment may be assembled at step 212 for all defensive plays associated with one team and a separate functional segment may be assembled for all special teams plays. The functional segments represent segmented multi-view recordings of the event.

In the embodiment, the steps 200-212 are performed at a computer under the control of an operator. The operator manually enters information necessary to synchronize the recording tracks (at step 202). The operator also is afforded the ability to adjust the formatting (at step 206) associated with multiple video tracks. For example, the user may adjust the size, position and number of different videos co-displayed with one another. The user also adjusts the resolution, contrast and other video parameters. The user may also oversee partitioning of the multi-view track and reassembling the functional segments through a user interface provided at the recorder/editor 16. Optionally, one or more of the steps 200-212 may be performed automatically without operator intervention.

Once the event is reformatted properly and reassembled into the corrected functional segments, the user instructs the recorder/editor 16 to load the segmented multi-view event recordings on to the server 17 (FIG. 1). The server 17 may be located at the college campus at which the event occurred. For example, the server 17 and event recorder/editor 16 may be located within an administrative office or the athletic department of the college. Once the server 17 receives the multi-view event recordings, the server automatically downloads the multi-view event recordings are over a restricted access network 19 to the system manager 12. Optionally, the server 17 may forward the original, unedited event recordings from the cameras 14 over the restricted access network 19 to the server 21 at the system manager 12. Examples of restricted access networks 19 are described below in more detail. The multi-view event recordings is passed over the restricted access network 19 to server 21 located at the system manager 12. The composite event review files (and the original event recordings generated by cameras 14) represent large, full-length versions of the event. The recorder/editor 16 and server 17 may compress the files containing the recordings utilizing lossy or non-lossy compression techniques. Lossy compression techniques are not utilized when it is desirable to maintain the detailed resolution captured by the event cameras 14.

Optionally, the recorder/editor 16 may forward the original event recordings and composite event review files to the system manager 12 over link 18 (e.g., over a fiber optic, T1 connection, T3 connection and the like) in analog or digital form. The recorder/editor 16 may forward to the system manager 12 the original event recordings associated with multiple cameras 14 as a single analog or digital file. Alternatively, separate analog or digital files may be sent to the system manager 12 for event recordings associated with select individual cameras 14 (e.g., one recording for a sideline camera and one recording for an end-zone camera). The recorder/editor 16 may also transmit the original and multi-view event recordings over a satellite link 20 or RF link 22.

The recorder/editor 16 may also provide event content to an event review display 24 for review during or immediately after an event. As an example, the event review display 24 may represent a display provided along the side line of the event for use during an event by officials to review individual plays and officiating calls. As a further example, the event review display 24 may be provided to TV broadcasting crews, news announcers and the like.

Once the recorder/editor 16 provides the multi-view event recording to the system manager 12, the system manager 12 stores it in a database 26. A controller 28 utilizes user information 30 and a routing log 32 to manage the subsequent preparation, retransmission, editing, secure review, exchange and the like. A user terminal 34 at the system manager 12 enables a user to edit and reformat the original and multi-view event recordings. Optionally, the controller 28 and/or user terminal 34 may include all of the functionality of the recorder/editor 16 described above in connection with FIG. 4. Hence, the user terminal 34 and/or controller 28 may manually and/or automatically synchronize, reformat and merge the original event recordings.

FIG. 2 illustrates one example of how event recordings from multiple cameras 14 associated with a single event may be combined and reformatted for presentation simultaneously on a common display. The display 40 may be shown on recorder/editor 16, user terminal 34, review station 52, 56, 58, home PC, laptop, PDA and the like. FIG. 2 illustrates a display 40 configured in a “review format” to co-display views 42 and 44 in a side-by-side alignment. The views 42 and 44 may be associated with separate cameras 14 denoted camera #1 and camera #2. For example, when the event is a football game, camera #1 may be positioned in the end zone, while camera #2 may be positioned along the side line. In this example, display 40 will simultaneously present video replays of the event from the end zone and side line cameras 14.

Optionally, the display 40 may co-display more than two views, such as four views partitioned into four quadrants of the display 40. The additional views may include cameras 14 that provide other view perspectives or angles of the game and/or cameras 14 dedicated to particular players, spectators, coaches, officials, the game clock, the score board and the like. Optionally, the display 40 may include an area 46 in which annotation information may be added, such as by the user via the user terminal 34, (by conference coordinators via review station 52 and by TAs via review/editor station 56). Examples of annotation information include statistics, indicia identifying each camera, the team names, officiating crew names, the game clock, notes regarding particular plays, and the like. Optionally, the annotation information may include a visual indicator denoting when an official blows a whistle to call a play dead, when a coach has challenged a particular play and the like.

The system manager 12 may include a website host module 54 that maintains a website that is accessible either through the internet 53 or through restricted access network 19. The website host module 54 may post the 2 event recordings at a particular site for subsequent downloading by various review and editor workstations 52, 56, 58 etc.

The original and/or multi-view event recordings and/or composite event review files may be passed to a conference coordinator review station 52. The review station 52 accesses the 2 event recordings directly or through a server 51. The server 51 may communicate with the management system 12 over the internet 53 or through the restricted access network 19. Optionally, the conference coordinator review station 52 represents a PC, that is used to log onto the website maintained by the website host 54. Original and/or multi-view event recordings associated with each football game in the SEC conference are passed over the restricted access network 19 or internet 53, or made available to the conference coordinator review station 52 for review by SEC conference personnel, while the 2 event recordings associated with each football game in the Big 12 conference are passed to a separate conference coordinator review station 52 for review by Big 12 conference personnel.

The 2 event recordings may also be passed over the internet 53 to the technical assistant (TA) review stations 56. The TA may be a coach, an ex-official and the like. The TA review station 56 may represent a home PC. The TA review station 56 includes video and audio control commands to provide the TA with total control over the video replay of the event, such as fast-forward, skip forward, reverse, skip backward, pause, slow motion, stop and the like. The TA review station 56 also includes a keyboard and a microphone to enable the technical assistant to type and/or record verbal statements or notes such as to comment on a particular play and an official or a player. Optionally, the TA review station 56 may include a touch sensitive screen or other user interface enabling the TA to stop the replay of the game at a particular point, draw directly on the screen (e.g., by circling a feature of interest, drawing an arrow and the like). The TA accesses the recordings through the internet by logging onto the website maintained by the website host 54 and downloading the appropriate files.

The technical assistants review the 2 event recordings for various reasons, such as to assess the judgment, actions and overall performance of the officiating crew. For example, the technical assistants may consider factors such as whether individual officials are in proper position with respect to particular plays, as well as whether the individual official is focusing upon the most relevant aspects of the play. When the technical assistant identifies individual plays that warrant feedback to the official, the technical assistant, through the TA review station 56, may create a critique clip by tagging the beginning and ending of the relevant video segment and adding associated feedback (e.g., official is in improper position with respect to play). The TA review station 56 may generate a video segment critique clip as a separate TA clip file containing a short video segment of one or more event portions (e.g., plays), along with the audio associated with the event portion. The TA clip file also includes the feedback provided by the TA. The feedback may be recorded as an audio note or may be entered as text, graphics, highlighting directly on the video and the like. The TA may verbally record the critique statements by speaking into a microphone, typing out text explaining the critique, circling key items in the display and the like. Text critiques may be shown in the area 46 (FIG. 2) as annotation information.

The TA review station 56 returns the TA clip files and/or original and/or multi-view event recordings (annotated with critique information) to the system manager 12 through website host 54 for storage in the database 26 and subsequent rerouting. When the TA clip files are combined with video segments or the original or multi-view event recordings, the combination represents an annotated event recording or segment (collectively, composite event review file). The system manager 12 passes the TA clip files and/or composite event review files (with or without annotated critique information) to the training file access workstations 58 over the internet 53 or by posting the files to the website through website host 54. Workstations 58 are used by the officials to review prior 2 event recordings, composite event review files, critique information in the TA clip files and the like. Individual officials may review their respective individual critique information at workstations 58 or at home on a PC. Optionally, officiating crews may review together the composite event review files, clip files and critique information.

The user information 30 may be entered individually for each end-user, for each class of users (e.g., coaching class, officiating class, conference coordinators, etc.), each type of event and the like. The controller 28 uses the user information 30 to direct the system manager 12 process 2 event recordings and/or composite event review files in a particular matter based upon the source of the event recording and the intended end user. For example, certain officiating crews may prefer certain combinations of camera angles. As another example, technical assistants may prefer different combinations of camera views in order to critique different types of officials (e.g., the line judge, the referee, etc.).

The routing log 32 includes routing information associating each event recording and/or composite event review file in a one-to-one relation with corresponding workstations, servers and/or end-users. For example, the routing log 32 may include the season schedule for the SEC conference and at the end of each game route the event recordings and event review files to corresponding schools (at event video exchange modules 74) scheduled to compete with one another the next week. The routing information 32 may include e-mail addresses, exchange server addresses and the like.

Optionally, the system manager 12 may provide any of the above discussed files and other information over a wireless link 62 to handheld portable review stations 64. The handheld portable review stations 64 may also receive the event content from the event content recorder/editor 16 over link 22. Optionally, the system manager 12 may obtain the broadcast version of an event over link 66 (which may be the internet 53, or another type of link). The system manager 12 would then permit a user, via user terminal 34, to edit the broadcast version to produce highlight reels that may be provided to the colleges, other users and the like.

Optionally, the system manager 12 may provide event recordings, composite event review files, clip files and the like over link 66 to a broadcast network 68. For example, following a game, broadcast announcers may review the event recordings and/or composite event review files at event review displays 24 to add commentary (e.g., audio recordings, text, graphics, highlighting and the like) to form annotated broadcast highlights. The annotated broadcast highlights within passed through the system manager 12 over link 66 to the broadcast network 68.

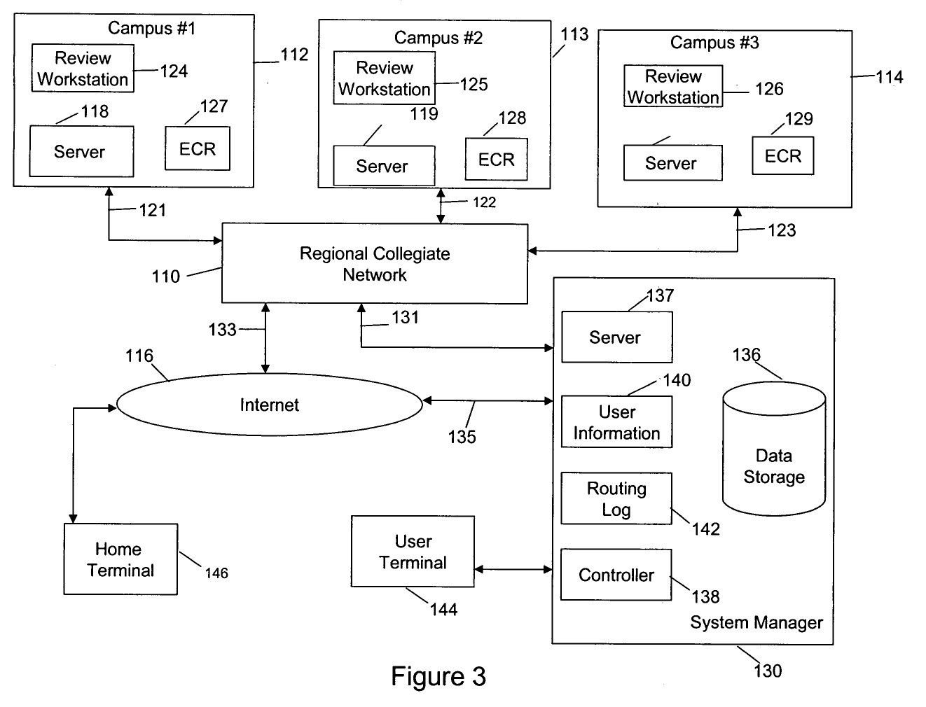

FIG. 3 illustrates a video content distribution and management system 100 implemented in connection with a select group of college campuses over a restricted access networks such as a regional collegiate network 110 interconnecting the computer networks of each campus (denoted 112-114). Examples of restricted access networks 110 include the Southern Crossroads (SoX network) which represents a cooperative initiative by the members of the Southeastern University's Research Association. The SoX network was designed to facilitate access to current and future highly integrated, digital communications services for education, research and economic development within the region. The network 110 is physically separate from and functionally distinct from the public internet 116. The network 110 represents a regional private network backbone dedicated to a region or group of colleges who are members in the supporting association, such as the Southern Crossroads network. The SoX network is only one example of a regional private network.

Another example of a restricted access network is the Abilene network, which represents a cross-country backbone having a 10 GB/second capacity, with the goal of offering 100 MB/second of connectivity between every Abilene connected desktop. The Abilene network is an internet two high performance backbone network and connects regional network aggregation points called giga-POPS. Another example of a restricted access network is the Quest network.

Each of college campuses 112-114 has one or more servers 118-120 associated therewith that communicate with the network 110 over links 121-123. Each server 118-120 has one or more unique destination addresses associated therewith. The servers 118-120 are connected with a variety of devices at the college campus including, but not limited to, one or more review/editor workstations 124-126. The servers 118-120 may be physically located at the college campus or remote from the campus.

In one exemplary application, the servers 118-120 may represent the servers that support the athletic departments within each campus 112-114. Audio and video recordings of collegiate events are loaded onto the workstations 124-125 from event content recorders 127-129. The event content recorders 127-129 may operate similar to the cameras 14 (FIG. 1). For example, an event content recorder 127 may record a football game played by the home team of the college 112 as an event recording. The event recording may then be edited and/or reformatted at the workstation 124 (as explained above in connection with FIG. 4). For example, editing and reformatting may include adding header ID information segmenting an event recording of a football into separate functional segments, such as for all offensive plays, all defensive plays and all special teams and/or kicking plays. Each event recorders may include a header identifying the source and/or event. The servers 118-120 transmit the original and/or multi-view event recordings automatically (e.g., at a predetermined time in the middle of the night), or under command of a user (e.g., after the game is over).

The original and/or multi-view event recordings, in its original full-length format and/or in the format segmented by function, is then passed over link 121 and the restricted access network 110 to a system manager 130. The system manager 130 may be interconnected with the regional collegiate network 110 over a dedicated secure link 131 and/or via the public internet 116 through less secure links 133 and 135.

The system manager 130 stores the original and/or multi-view event recordings (segmented and/or original) in a data base 136. A controller 138 utilizes user information 140 and a routing log 142 to manage and distribute the original and/or multi-view event recordings for subsequent preparation, retransmission, editing, secure review, exchange and the like. The system manager 130 automatically determines the source and/or content of original and/or multi-view event recordings such as based on a header. The system manager 130 may determine the source/content of each original and/or multi-view event recordings based on the IP address of the server 118-120, transmitting a particular event review file. Alternatively, the server 118-120 may provide source ID information to the system manager 130 immediately prior to transmitting the event review file. Optionally, the system manager 130 may individually and periodically poll each of servers 118-120 to request the event review files. One or more user terminals 144 are provided with the system manager 130 to enable an user to edit and reformat the original and/or multi-view event recordings.

In one embodiment, the system manager 130 may provide an automated mechanism for redistributing original and/or multi-view event recordings between designated colleges 112-114 based on the season schedule. For example, the routing log 114 may store a schedule for all of the football games to be played by each of the colleges 112-114 in a conference. When colleges 112-114 are to play one another, football game videos are exchanged between the colleges by the system manager 130. For example, assume in week #1 Georgia Tech plays North Carolina and Connecticut plays North Carolina State. In week #2, Georgia Tech is scheduled to play Connecticut. Then after the week #1 game, the original and/or multi-view event recordings for the football game for the Georgia Tech versus North Carolina game is passed through the network 110 to the system manager 130 from the server 118 at the Georgia Tech campus 112. The system manager 130 then reroutes the original and/or multi-view event recordings of the Georgia Tech versus North Carolina football game and/or the original and/or multi-view event recordings related to the Georgia Tech versus North Carolina football game to Connecticut (which may be represented by the server 119 and college 114 in FIG. 3).

Similarly, the server 119 associated with the Connecticut campus 114 would pass to the system manager 130 through the network 110, the original and/or multi-view event recordings associated with Connecticut's most recent football game (e.g., versus North Carolina State). The Connecticut versus North Carolina State football game event recording would then be passed from the system manager 130 through the network 110 to the server 118 at the Georgia Tech campus 112. In the foregoing manner, the system manager 130 provides an automated managed exchange of original and/or multi-view event recordings (e.g., football game videos) between college campuses within a regional conference.

In addition, the original and/or multi-view event recordings may be reviewed at the system manager (via user terminal 144) by ex-game officials hired by the conference to provide service for the conference. These ex-gaming officials or TAs may review the performance of officiating crews in connection with each game, such as the positioning of the officials on the field and the decisions by the officials throughout the game. The ex-game officials or TAs will create at the user terminal one or more critique clip electronic files associated with each event review file. For example, each individual critique clip file may be associated with the performance of an individual official. Hence, multiple critique files will be created in connection with each original and/or multi-view event recordings, one for each official. The comments and critiques of the technical assistant are recorded with the original and/or multi-view event recordings. Optionally, the user terminal 144 may be a home PC of a TA.

Once the critique files are prepared, the composite event review file is stored in database 136 and transmitted by system manager 130 over the network 110 or internet 116 to a designated internet address. The destination address(es) may be recorded in the routing log 142. The destination address(es) may be one or more of server 118-120, user terminals 144, an email address, TA review stations, a server managed by the conference and the like. The composite event review file is then reviewed by the officiating crew prior to the next game. The review may be as a group or individually. The review may include all or only portions of the prior event.

Optionally, a website host 145 is utilized with the system manager 130 to post the composite event review files at a website that has restricted access. The conference coordinator, officials, TAs, coaches and the like may separately and independently access the website, login and download desired files for review and editing. Depending upon the user privileges provided to the conference coordinator, TA, official and coach, the user may then edit the files and repost the edited file at the website. When a new file is posted at the website, the website host 145 notifies the system manager 130 that in turn determines what action and subsequent routing should be undertaken in connection with the newly loaded file.

Optionally, officials may utilize home terminals 146 to review composite event review files including the critique of the corresponding official. Optionally, coaches may use home terminals 146 to review event recordings and event review files stored in data storage 136.

The training assistants may utilize an established grading system to grade the individual officials work in connection each game. Access to the individual comments and critique of each official may be password protected or protected based on different levels of user privileges. For example, a conference coordinator may have the authority to access the system manager 130 and review any official critiques, while individual officials may only be able to access their corresponding individual critique files, while coaches may only be able to access event recordings of the games without having access to any of the official critique files.

A video editor employed by each of colleges may access the server 137 at the system manager 130 to order various game videos.

Optionally, satellite links 70 and 72 may be provided to the system manager 12 and event video exchange modules 74.

The term “camera” includes any electronic device capable of capturing in analog or digital form one or more images, including video cameras or photographic cameras, digital cameras, cellular phones, personal digital assistants, global positioning system units, binoculars, and the like carried by individuals at an event.

The term “event” includes any type of forum at which a group of people congregate for a common purpose, such as sporting events, educational seminars, entertainment events, religious events, business events, concerts, conventions, social events, networking events, commercial buildings, office environments, department stores and the like.

The term “public forum” includes any locate other than an individuals home, such as a stadium, a field, a park, a playground, an office, a store, a convention center, a community center, a government building, a commercial building.

While the invention has been described in terms of various specific embodiments, those skilled in the art will recognize that the invention can be practiced with modification within the spirit and scope of the claims.

What is claimed is:

1. A system for managing distribution of video content between colleges, the system comprising:
a first server, associated with a first college, the first server receiving an event recording associated with an event related to the first college, the first server being configured to transmit the event recording over a restricted access network; and
a system manager configured to communicate with the first server and receive the event recording from the first server over the restricted access network, the system manager rerouting the event recording over the restricted access network to a second server associated with a second college.

2. The system of claim 1, wherein the restricted access network is not the internet.

3. The system of claim 1, wherein the restricted access network represents the Southern Crossroads network interconnecting collegiate campuses within the Southeastern Conference.

4. The system of claim 1, wherein the event recording includes at least one of a recording of a complete event, portions of an event, functional segments of an event, files containing comments associated with the event, and critique files storing critique information associated with an individual official at a sporting event.

5. The system of claim 1, further comprising a workstation for segmenting the event recording of a game into functional segments divided based on play type.

6. The system of claim 1, further comprising an event content recorder located at the first college for recording the event recording.

7. The system of claim 1, further comprising a workstation for reviewing the event recording and for annotating the event recording with critique information associated with the event.

8. The system of claim 1, wherein the system manager forms a composite event review file based on the event recording and critique information associated with the event, the system manager transmitting the composite event review file to a destination address based on a routing log.

9. The system of claim 1, further comprising a routing log storing a routing schedule in a one-to-one relationship with source/destination IP addresses, the system manager rerouting the event recording based on the routing log.

10. A method for managing distribution of video content between colleges, the method comprising:
receiving, at a first server associated with a first college, an event recording associated with an event related to the first college;
transmitting the event recording from the first server over a restricted access network to a system manager; and
rerouting the event recording from the system manager over the restricted access network to a second server associated with a second college.

11. The method of claim 10, wherein the restricted access network is not the internet.

12. The method of claim 10, wherein the transmitting transmits the event recording over the Southern Crossroads network interconnecting collegiate campuses within the Southeastern Conference.

13. The method of claim 10, further comprising including, in the event recording, at least one of a recording of a complete event, portions of an event, functional segments of an event, files containing comments associated with the event, and critique files storing critique information associated with an individual official at a sporting event.

14. The method of claim 10 further comprising segmenting the event recording of a game into functional segments divided based on play type.

15. The method of claim 10, reviewing the event recording and annotating the event recording with critique information associated with the event.

16. The method of claim 10, further comprising forming a composite event review file based on the event recording and critique information associated with the event; and transmitting the composite event review file to a destination address based on a routing log.

17. The method of claim 10, further comprising storing a routing schedule in a one-to-one relationship with source/destination IP addresses, the rerouting of the event recording being based on the routing log.
